(19) United States
(12) Patent Application Publication
(10) Pub. No.: US 2022/0156805 A1
(43) Pub. Date: May 19, 2022

(54) METHOD OF PRODUCT QUALITY TRACING AND PREDICTION BASED ON SOCIAL MEDIA

(71) Applicants: Inventec (Pudong) Technology Corporation, Shanghai (CN); INVENTEC CORPORATION, Taipei (TW)

(72) Inventors: Trista Pei-Chun Chen, Taipei (TW); Po-Sen Chiu, Taipei (TW)

(21) Appl. No.: 17/166,109

(22) Filed: Feb. 3, 2021

(30) Foreign Application Priority Data
Nov. 19, 2020 (CN) 202011299176.3

(51) Int. Cl. G06Q 30/02; G06K 9/62; G06F 40/20; G06F 16/901; G06Q 50/00

(52) U.S. Cl. CPC G06Q 30/0282; G06K 9/6267; G06Q 50/01; G06F 16/9027; G06F 40/20

(57) ABSTRACT

Product quality tracing method based on social media comprises obtaining a first edit distance between each of strings from social media data and one of names corresponding to a product in a lookup table, classifying the strings having the first edit distance smaller than a first threshold in order to obtain a first target string, configuring at least part of social media data having the first target string as product data, obtaining a second edit distance between each of strings from product data and a problem keyword, classifying the strings having the second edit distance smaller than a second threshold in order to obtain a second target string, obtaining and configuring a number of product data corresponding to the second target string as a problem value, and generating a product quality list according to the lookup table, problem keyword and the problem value.

### CROSS-REFERENCE TO RELATED APPLICATIONS

This non-provisional application claims priority under 35 U.S.C. § 119(a) on Patent Application No(s). 202011299176.3 filed in China on Nov. 19, 2020, the entire contents of which are hereby incorporated by reference.

### BACKGROUND

### 1. Technical Field

This disclosure relates to a method of product quality tracing and prediction, and particularly to a method of product quality tracing and prediction based on social media.

### 2. Related Art

Quality assurance is important with respect to a product which is about to be on sale. Manufacturer and sellers usually operates multiple tests and problem testing before the product going on sale. However, is it extremely difficult to foresee every possible problem, perform testing and solve every problem successfully. Therefore, quality control and quality monitoring (tracing quality issues after product leaving factory) after sale is equally important.

Conventionally, sellers collect product feedbacks via the physical or internet feedback card or a questionnaire that is similar to the feedback card. However, according to Esteban Kolsky, “Customer Experience For Executives”, it is recited that “13% of unhappy customers will share their complaint with 15 or more people, and only 1 in 25 unhappy customers complain directly to the business.” More specifically, unhappy customers may share on the social media, unofficial forums, etc. That is, quality feedback for further quality improvement or issue prevention is mostly hidden from the business if the business doesn't actively search for the feedbacks of the product in the web site such as social media. To the highly social-media-relying modern society, lacks of feedbacks on social media is equivalent to lacks of massive amount of product quality feedback resource. Thus, a method of tracing or even predicting the product quality based on artificial intelligence and via analysis of feedbacks on social media is needed.

### SUMMARY

According to one or more embodiment of this disclosure, a product quality tracing method based on social media comprises: obtaining a lookup table comprising a plurality of names associated to a product; obtaining a plurality of social media data; obtaining a first edit distance between each of a plurality of first strings and one of the plurality of names according to the lookup table, with the plurality of first strings obtained from the plurality of social media data; classifying the first strings to obtain a first target string associated to the product, with said first target string having the first edit distance smaller than a first threshold; defining at least a part of the plurality of social media data having the first target string as a plurality of product data; obtaining a second edit distance between each of a plurality of second strings and a problem keyword according to the problem keyword, with the plurality of second strings obtained from the plurality of product data; classifying the second strings to obtain a second target string associated to the problem keyword, with said second target string having the second edit distance smaller than a second threshold; obtaining a number of the plurality of product data associated to the second target string and defining said number as a problem value; and generating a product quality list according to the lookup table, the problem keyword and the problem value.

According to one or more embodiment of this disclosure, a product quality predicting method based on social media comprises: obtaining a product quality list corresponding to the product of the embodiment above; obtaining a similarity between a second product and the product; and generating a predicted quality list associated to the second product according to the similarity and the product quality list, wherein the similarity is a similarity between a predicted problem value of the predicted quality list and the problem value.

### BRIEF DESCRIPTION OF THE DRAWINGS

The present disclosure will become more fully understood from the detailed description given hereinbelow and the accompanying drawings which are given by way of illustration only and thus are not limitative of the present disclosure and wherein:

FIG. 1 is an example of device block diagram of the product quality tracing and predicting method based on social media according to an embodiment of the present disclosure;

FIG. 2 is a flow chart of the product quality tracing method based on social media according to an embodiment of the present disclosure;

FIG. 3 is a flow chart of the product quality predicting method based on social media according to an embodiment of the present disclosure; and

FIG. 4 is a schematic diagram of lineage tree according to an embodiment of the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

In addition, the terms used in the present disclosure, such as technical and scientific terms, have its own meanings and can be comprehended by those skilled in the art, unless the terms are additionally defined in the present disclosure. That is, the terms used in the following paragraphs should be read on the meaning commonly used in the related fields and will not be overly explained, unless the terms have a specific meaning in the present disclosure.

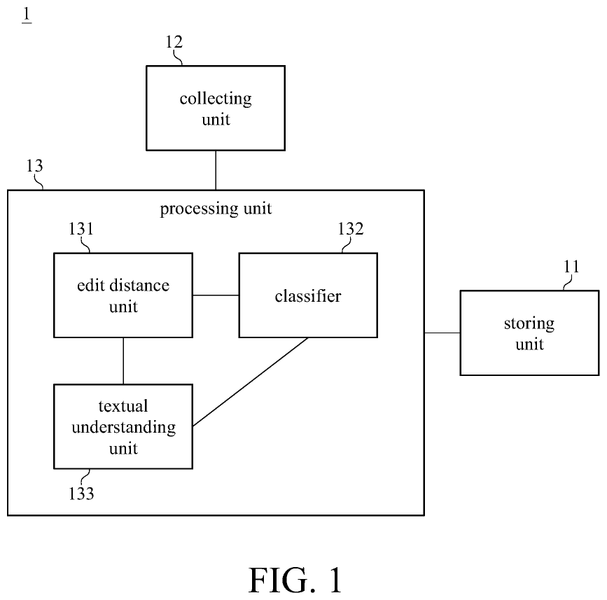

The product quality tracing method based on social media according to an embodiment of the present disclosure collects the information corresponding to the product quality on the social media, and uses it to trace the product quality condition, and even predict the quality condition of a new product corresponding to the product. Please refer to FIG. 1, the product quality detection device 1 is applicable to the product quality tracing and predicting method based on social media according to an embodiment of the present disclosure. However, FIG. 1 is merely one of the embodiments practicing the method of the present disclosure, and the present disclosure does not limit to the applicable device. Product quality detection device 1 in FIG. 1 comprises a storing unit 11, a collecting unit 12 and a processing unit 13, wherein the processing unit 13 connects the storing unit 11 and the collecting unit 12. The processing unit 13 comprises an edit distance unit 131, a classifier 131 and a textual understanding unit 133, and the components 131-133 may connect to each other so as to interconnect the data.

The storing unit 11 may be a memory, configured to provide data access to the processing unit 13. The collecting unit 12 may execute the operation such as web crawling. The processing unit 13 is configured to process the data obtained by the collecting unit 12, wherein the edit distance unit 131 is configured to calculate an edit distance between the any strings and a predetermined string. An edit distance is a quantized measurement of a difference degree between two strings (e.g., English words), which the measure method is to determining how many times of process is needed to transform a string into another word. For instance, the edit distance between “a” and “an” is 1 (“adding n” to “a” to obtain “an”), the edit distance between “have” and “has” is 2 (“substitute v with s” and “delete e” to “have” to obtain “has”) . . . etc. Levenshtein distance may be adapted to an embodiment of the present disclosure. The classifier 132 may be a binary classifier and is configured to gather the objects having similar characteristic, and uses it to classify the data. The textual understanding unit 133 may process natural language processing, and is configured to obtain a characteristic of a string according to the statistic feature in the context of the data. The characteristic may be a word vector or a tag of the type of the word, or the like, the present disclosure does not limit to this. The three components 131-133 may operates with each other in different situation in order to obtain different effect.

For example, if the data of a product “Wonderbook 12 inch” is wished to be searched for on social media, the processing unit 13 may utilize the edit distance unit 131 to calculate a first edit distance between each of strings in the social media data obtained by the collecting unit 12 and “Wonderbook 12 inch”, and obtain a plurality of strings, each of whom having a first distance smaller then a first threshold. The first threshold may be considered as a tolerance of typos. However, those strings are not exactly equal to “Wonderbook 12 inch”, sometimes the strings having a first distance smaller then a first threshold may represent whole different thing. For example, “Wonder woman book 12 yrs” is within the tolerance in a setting, and is a string having the first edit distance smaller than the first threshold. However, “Wonder woman book 12 yrs” may refer to the wonder woman comic in 2012, and “Wonderbook 12 inch” may refer to a model of a 12 inches' laptop, wherein the two are different. Thus, the processing unit 13 may further utilize the textual understanding unit 133 to respectively obtain the characteristic of the strings having the first edit distance smaller than the first threshold according to the context of textual of the social media data, and then the classifier 132 classifies the characteristics of the strings according to the characteristic of “Wonderbook 12 inch” and obtains the string having the characteristics similar or equal to the characteristic of “Wonderbook 12 inch”. At this time, the string classified by the classifier 132 may be considered to be corresponding to “Wonderbook 12 inch” and may be recited as a first target string. Lastly, the data having the first target string may be configured as the product data corresponding to the product. Here, the “configured as” may be seen as “defined as”.

Here, another example is provided. The product quality detection device 1 of an embodiment of the present disclosure may further search for the problems corresponding to the product in the above product information corresponding to the product, and collect a problem value. Such problems, for instance, may be about the bad cooling, slow Bluetooth connection speed, dead points on the panel or the like corresponding to the product. Under the circumstances, a problem keyword may be predetermined, such as “cooling”, “Bluetooth”, “panel” or the like. However, the present disclosure does not limit to the degree of description of the problem keyword, and in the other embodiment, the problem keyword may further describe the object and the rough condition, such as “bad cooling”, “Bluetooth connection disorder”, “defective panel pixel” or the like.

In view of the above description, through the product quality tracing and predicting method based on social media, the product quality list is generated according to the problem value obtained respectively according to the problem keyword in the product data, corresponding to the product, among the social media. Then the predicted quality list corresponding the second product is generated according to the product quality list and the similarity between the product and the second product. By such, it is possible to effectively trace the problem condition of the product and the amount on the social media, and predict the problem which is likely to be faced before the second product having similar design to the product is out. The processing unit 13 may utilize the edit distance unit 131 to calculate a second edit distance between each of the strings of the plurality of product data and the problem keyword, and obtain a plurality of strings having the second edit distance smaller than a second threshold. But as described above that the words having different meaning to the origin may be included while allowing typos, the processing unit 13 may further utilize the textual understanding unit 133 to respectively obtain characteristic of the strings having the second edit distance smaller than the second threshold according to the context of the product data, and then the classifier 132 classifies the strings according to the characteristic of the predetermined problem keyword and obtains the string having the characteristics similar or equal to the characteristic of the problem keyword. At this time, the string classified by the classifier 132 may be considered to be corresponding to the problem keyword and may be recited as a second target string. Lastly, the processing unit 13 may obtain and configure a number of the data corresponding to the second target string as the problem value. For instance, if text “received the good for just few days and the brightness of the ‘panel’ is so uneven” is referred in the product data, it may be considered a problem data about “panel”, thereby increasing the problem value of panel statistically, wherein the problem value may be in a numeral form or a percentage comparing to the total product data.

In addition, since sometimes the problem keyword may not be included in the description text about the problem in the product data, in the process of “obtaining and configuring (the configuring hereinafter may be seen as “defining”) the number of the plurality of product data corresponding to the second target string as the problem value”, the processing unit 13 may continue to utilize the textual understanding unit 133 to analyze whether the text in the product data implies the second target string, and determine the product data implying the second target string to be the problem data, thereby increasing problem value statistically. For instance, although text “connected the charger port for just few minutes and the case is hot as hell” in the product does not directly comprise “cooling”, it may still be considered as a problem about cooling.

Therefore, by utilizing the product quality detection device, the product quality tracing and predicting method based on social media may be practiced. Here, the product quality tracing method based on social media based on an embodiment of the present disclosure is described in advance, and the product quality tracing method based on social media will be described afterward, wherein the prediction of the product quality tracing method based on social media is based on the result of the product quality tracing method based on social media.

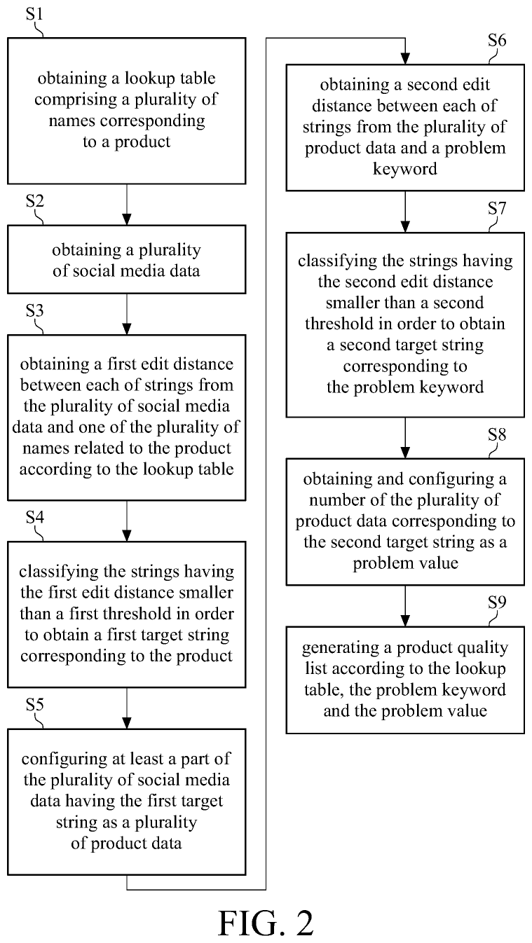

Please refer to FIG. 2. FIG. 2 is a flow chart of the product quality tracing method based on social media according to an embodiment of the present disclosure, wherein the method comprises the steps of: step S1, obtaining a lookup table comprising a plurality of names corresponding to a product; step S2, obtaining a plurality of social media data; step S3, obtaining a first edit distance between each of strings from the plurality of social media data and one of the plurality of names corresponding to the product according to the lookup table; step S4, classifying the strings having the first edit distance smaller than a first threshold in order to obtain a first target string corresponding to the product; step S5, configuring at least a part of the plurality of social media data having the first target string as a plurality of product data; step S6, obtaining a second edit distance between each of strings from the plurality of product data and a problem keyword; step S7, classifying the strings having the second edit distance smaller than a second threshold in order to obtain a second target string corresponding to the problem keyword; step S8, obtaining and configuring a number of the plurality of product data corresponding to the second target string as a problem value; and step S9, generating a product quality list according to the lookup table, the problem keyword and the problem value. Hereinafter, the “configuring as” hereinafter may be seen as “defining as”.

The lookup table in step S1 may be stored in the storing unit 11, and the plurality of names comprised in the lookup table may be an internal name and a marketing name corresponding to the product. The internal name may be the model serial number named by business of sellers, and which is the name usually used by the internal of sellers. The marketing name may be the name announced to the market. For instance, the internal name may be “DEF Wonderbook 122” which represents the Wonderbook of model 122 of DEF series, and the corresponding marketing name may be the name often seen in the market, such as “Wonderbook Compact”, “Wonderbook 12 inch”, or the like.

Step S2 may utilize the collecting unit 12 to execute web crawling, obtaining a plurality of social media data on the internet. Wherein the unit of the social data maybe a post, a thread, a tweet, or the like.

In step S3, the storing unit 11 sends the lookup table to the processing unit 13, and the edit distance unit 131 utilizes the internal name or the marketing name in the lookup table to obtain the first edit distance between each of strings from the plurality of social media data and one of the internal name or the marketing name. Here, the present disclosure does not limit the usage of the internal name or the marketing name. Specifically, the edit distance unit 131 may respectively obtain the first edit distance between each of strings from the plurality of social media data and the internal name and between each of strings from the plurality of social media data the marketing name, thereby the data corresponding to one of the two names will not be missed when obtaining the edit distance between the string and the other one of the two names.

In step S4, the textual understanding unit 133 obtains the characteristics of the strings having the first edit distance smaller than the first threshold, and the classifier 132 classifies and configures the string having the characteristics similar or equal to the characteristic of the internal name or the marketing name as the first target string. In another embodiment, the processing unit 13 may utilize an algorithm such as a support vector machine, a multilayer perceptron or the like to obtain the first target string, the present disclosure does not limit to this. Thereby, even typos corresponding to the product exist in the posts of the social media, it is still effective for the present method that include the typos as the object being detected.

In step S5, the processing unit 13 may configure the plurality of social media data having the first target string as the plurality of product data. However, in practice, the data corresponding to the product may not only be the thoughts of using the product after sale, but also be the anticipation or analysis of the product before sale. Since an embodiment of the present disclosure focuses on the quality assurance of product using, thus specifically, the processing unit 13 may further determine whether each of a plurality of time tags of the at least part of the plurality of social media data is later than a time threshold, and configure the at least part of the plurality of social media data having the time tags later than the time threshold as the plurality of product data. With this, any posts before sale may be seen to be excluded from the social media data if the time threshold is predetermined as the sale date.

From step S1 to step S5, it may be seen that the product data corresponding the product is successfully obtained on the internet. Therefore, the problem corresponding the product may be obtained in the latter steps. Steps S6 to S7 continue to utilize the three component 131-133 of the processing unit 13 to execute the operation similar to steps S3 to S4, and the difference is that the edit distance unit 131 obtains the plurality of “second edit distance” between each of strings from the plurality of “product data” and “the problem keyword”, and classifier 132 classifies and obtains the “second target string” corresponding to “the problem keyword” according to the characteristics obtained by the textual understanding unit 133. It may be seen as the same operation toward different material no matter the process in steps S3 to S4 or the process in steps S6 to S7. Wherein the problem keyword may be tags which are pre-stored in the storing unit 11 or are generated after the textual understanding unit 133 analyzing the product data, the present disclosure does not limit to the way of obtaining the problem keyword.

In step S8, more specific, besides directly considering the product data comprising the second target string as the problem data, the processing unit 13 may utilize the textual understanding unit 133 to determine whether the product data imply the second target string, and also consider those product data implying the second target string as the product data corresponding the second target string and as the problem data. Lastly the number of the problem data is configured as the problem value.

Lastly in step S9, the processing unit 13 generates the product quality list according to the lookup table, the problem keyword and the problem value. The product quality list may include a plurality of information, such as the product model, the problem types and the problem value thereto on the social media data, and even the relation between the problem value and the time after sale (e.g., complaints about phone jack rise after two weeks after sale, charge capacity of battery decrease massively after half year after sale or the like), or the like. The product quality list may be stored in the storing unit 11. The method of product quality tracing based on social media according to an embodiment of the present disclosure may update the product quality list at any time in order to keep the trace of the product problem on social media.

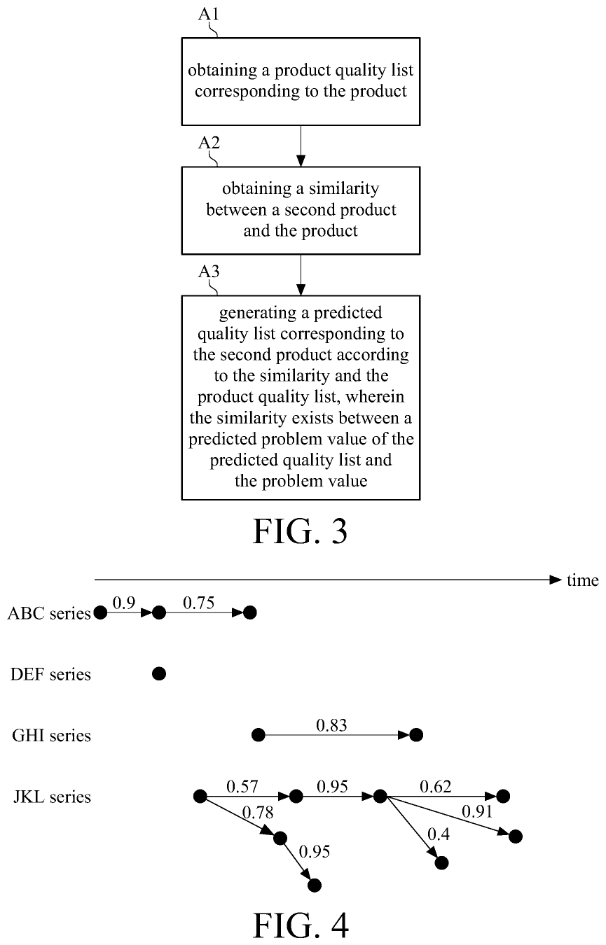

Here, the product quality predicting method based on social media according to an embodiment of the present disclosure is continually described. FIG. 3 is a flow chart of the product quality predicting method based on social media according to an embodiment of the present disclosure, and the method comprises the steps of: step A1, obtaining a product quality list corresponding to the product; step A2, obtaining a similarity between a second product and the product; and step A3, generating a predicted quality list corresponding to the second product according to the similarity and the product quality list, wherein the similarity exists between a predicted problem value of the predicted quality list and the problem value.

The second product is further disclosed in the flow chart of FIG. 3. The second product may be the next “new product” of the product disclosed in FIG. 2, and the two products may be in the same series released by the manufacture and thus a similarity between the two products exists. The product quality list of step A1 is a product quality list obtained by practicing the product quality tracing method based on social media of FIG. 2. The similarity of step A2 may be a calculated visual similarity in product design or a product design similarity with tree matching, and thus a numeral (or a percentage in other embodiment) may be obtained. As showed in FIG. 4, series A, B and C may be induced into the same design, and so are series D, E and F and series J, K and L. Wherein each dots may represent a product, and any value between two products represents a similarity between a new product and an old product. The predicted quality list corresponding to the second product in step A3 is generated by calculating the product quality list with the similarity. Since the second product is new in the series and is released in the same concept, therefore under the circumstances that the similarity exists between the two products, the problem encountered by the product may be used to predict the problem which the second product may encounter as well after sale, and it is altered according to the magnitude of the similarity.

In addition, after the sale of the second product, the problem of the second product may be traced by practicing the product quality tracing method based on social media according to an embodiment of the present disclosure. Under the circumstances, the lookup table may be further corresponding to the second product, and comprises an internal name and a marketing name of the second product. By practicing the product quality tracing method based on social media according to an embodiment of the present disclosure to the second product, a second product quality list corresponding to the second product may be obtained. Since the method is already specifically described above, here the description is omitted.

Besides, the predicted quality list and the second product quality list may be used to build a predicted model, thereby adjust the predicted quality list generated by the product quality detection device 1.

In view of the above description, through the product quality tracing and predicting method based on social media, the product quality list is generated according to the problem value obtained respectively according to the problem keyword in the product data, corresponding to the product, among the social media. Then the predicted quality list corresponding the second product is generated according to the product quality list and the similarity between the product and the second product. By such, it is possible to effectively trace the problem condition of the product and the amount on the social media, and predict the problem which is likely to be faced before the second product having similar design to the product is out.

It will be apparent to those skilled in the art that various modifications and variations can be made to the present disclosure. It is intended that the specification and examples be considered as exemplary embodiments only, with a scope of the disclosure being indicated by the following claims and their equivalents.

What is claimed is:

1. A product quality tracing method based on social media, comprising:
obtaining a lookup table comprising a plurality of names associated to a product;
obtaining a plurality of social media data;
obtaining a first edit distance between each of a plurality of first strings and one of the plurality of names according to the lookup table, with the plurality of first strings obtained from the plurality of social media data;
classifying the first strings to obtain a first target string associated to the product, with said first target string having the first edit distance smaller than a first threshold;
defining at least a part of the plurality of social media data having the first target string as a plurality of product data;
obtaining a second edit distance between each of a plurality of second strings and a problem keyword according to the problem keyword, with the plurality of second strings obtained from the plurality of product data;
classifying the second strings to obtain a second target string associated to the problem keyword, with said second target string having the second edit distance smaller than a second threshold;
obtaining a number of the plurality of product data associated to the second target string and defining said number as a problem value; and
generating a product quality list according to the lookup table, the problem keyword and the problem value.

2. The product quality tracing method based on social media according to claim 1, with each of the plurality of social media data having a time tag, wherein defining at least the part of the plurality of social media data having the first target string as the plurality of product data comprises:
determining whether a plurality of time tags of at least the part of the plurality of social media data are later than a time threshold; and
defining the social media data having the plurality of time tags later than the time threshold as the plurality of product data.

3. The product quality tracing method based on social media according to claim 1, wherein obtaining the number of the plurality of product data associated to the second target string and defining said number as the problem value comprises:
determining whether the plurality of product data associates to the second target string with natural language processing; and
defining the product data associated to the second target string as a plurality of problem data, and defining the number of the plurality of problem data as the problem value.

4. A product quality predicting method based on social media, comprising:
obtaining the product quality list corresponding to the product of claim 1;
obtaining a similarity between a second product and the product; and
generating a predicted quality list associated to the second product according to the similarity and the product quality list, wherein the similarity is a similarity between a predicted problem value of the predicted quality list and the problem value.

5. The product quality predicting method based on social media according to claim 4, wherein the similarity is a calculated visual similarity in product design or a product design similarity with tree matching.

6. The product quality predicting method based on social media according to claim 4, wherein the lookup table further associates to the second product, and wherein the method further comprises:
obtaining a second product quality list by the method of claim 1.

7. The product quality predicting method based on social media according to claim 6, wherein the method further comprises:
building a predicted model according to the predicted quality list and the second product quality list.
